(19) United States
(12) Patent Application Publication
(10) Pub. No.: US 2015/0093650 A1
(43) Pub. Date: Apr. 2, 2015

(54) BATTERY SEPARATOR

(71) Applicant: LENZING AKTIENGESELLSCHAFT, A-4860 Lenzing (AT)

(72) Inventors: Marco Gallo, A-4840 Vocklabruck (AT); Peter Andrew Slater, Nuneaton Warwickshire (GB); Chris Potter, Little Eaton Derby (GB)

(73) Assignee: LENZING AKTIENGESELLSCHAFT, Lenzing (AT)

(21) Appl. No.: 14/396,485

(22) PCT Filed: Feb. 22, 2013
(86) PCT No.: PCT/EP2013/053579

§ 371 Date: Oct. 23, 2014

(30) Foreign Application Priority Data
Apr. 26, 2012 (EP) 12165714.2

(51) Int. Cl. H01M 2/16

(52) U.S. Cl. CPC H01M 2/1626
USPC 429/255; 252/182.12

(57) ABSTRACT

The present invention relates to a battery separator, comprising cellulosic fibers of the lyocell genus, wherein the R10-value, the R18-value and the hemicellulose content of the lyocell fibers is as follows:
R10>83%, preferably >84%
R18>93%, preferably >94%
Hemicellulose content <3%.

The present invention furthermore relates to novel lyocell fibers useful for battery separators, as well as batteries comprising the inventive battery separator.

### BACKGROUND OF THE INVENTION

The present invention relates to the field of batteries, including alkaline (primary and secondary) and lithium batteries, which include separators comprising a porous layer including polymeric fibers.

Such separators serve to prevent an electrical connection between the anode and the cathode of the battery, or a short circuit.

Cellulosic fibers are widely employed in battery separators due to their ability to absorb and retain the electrolytes. However, some of these cellulosic fibers (like rayon or mercerized pulp) have poor fibrillation ability and, therefore, do not allow obtaining battery separators with the desired properties in terms of density, porosity and dimensional stability.

Cellulosic fibers of the lyocell genus are well known for their fibrillation ability and are employed in battery separators. Lyocell fibers are spun from a solution of cellulose in a tertiary amine-oxide.

Thanks to the fine and long fibrils, the separators made with such fibers have a suitable porosity, the ions mobility inside the battery is very good and the efficiency of the battery is high. The fibrils interlace very well during paper making and form a dense structure with low shrinkage and high dimensional stability. Moreover the average size of the pores is small, and this represents a barrier for dendrites.

The use of lyocell fibers in battery separators has been disclosed in EP 0 572 921 A1, US 2007/0014080 A1, US 2010/0310921 and US 2009/0017385 A1. WO 97/37392 discloses a battery separator made from a cellulose film formed from a solution of cellulose in an amine oxide. Further state of the art is provided by U.S. Pat. No. 5,700,700 and DE 198 55 644.

Especially in the case of alkaline batteries, the battery separator is required to have good chemical stability in the presence of strong electrolytes (such as 30-40% KOH). Further details about the requirements of battery separators in various types of batteries are disclosed in e.g. WO 2007/041312.

It is still desired to make battery separators with cellulosic fibers having an enhanced resistance towards alkali solutions.

Accordingly, in one aspect the present invention provides a battery separator, comprising cellulosic fibers of the lyocell genus, wherein the R10-value, the R18-value and the hemicellulose content of the lyocell fibers is as follows:
R10>83%, preferably >84%
R18>93%, preferably >94%
Hemicellulose content <3%.

In a further aspect, the present invention provides the use of a cellulosic fiber of the lyocell genus, said fiber exhibiting
a value for R10>83%, preferably >84%
a value for R18>93%, preferably >94%
a hemicellulose content <3%,
   in a battery separator.
   The present invention, furthermore, provides a cellulosic fiber of the lyocell genus, said fiber exhibiting
a value for R10>83%, preferably >84%
a value for R18>93%, preferably >94%
a hemicellulose content <3% and
a length of from 2 to 10 mm.

Finally, the present invention provides a battery, preferably an alkaline battery, comprising the battery separator according to the present invention.

### SHORT DESCRIPTION OF THE DRAWINGS

FIGS. 1 and 2 demonstrate the Alkali Resistance (FIG. 1) and Air Permeability (FIG. 2) properties of battery separators according to the present invention and comparative examples.

FIGS. 3 to 6 demonstrate the effect of the mercerisation of lyocell fibers on alkali resistance in terms of R10-value (FIGS. 3 and 5) and R18-value (FIGS. 4 and 6).

FIG. 7 shows the results of a Schopper-Riegler test on non-mercerised and mercerised lyocell fiber.

### DETAILED DESCRIPTION OF THE INVENTION

It has surprisingly been found that lyocell fibers with a certain set of properties, i.e. R10-value, R18-value and hemicellulose content, exhibit a much better resistance to electrolytes of especially alkaline batteries than standard lyocell fibers hitherto proposed for battery separators.

As known to the skilled artisan, the R10-value of a cellulosic substrate is the amount of undissolved residue when exposing the substrate to 10% NaOH. R18 reflects the amount of undissolved residue when exposing the substrate to 18% NaOH. Both values can be measured according to DIN 54355.

All values given within this application for R10, R18 and hemicellulose content are wt. %.

The content of hemicellulose is understood to be the sum of xylane and mannane. The method for determining the content of hemicellulose is set out further below.

When producing battery separators comprising lyocell fibers meeting the above specifications, it was found that the Reduction by Weight of the separator in 40% KOH was significantly reduced.

Furthermore, separators containing the above-specified lyocell fibers have lower Reduction by Area in 40% KOH compared to separators containing other cellulosic fibers.

Lyocell fibers with the above-specified properties have also a high degree of fibrillation when they are refined with the conventional beating systems. For example, the Canadian Standard Freeness (CSF) of the refined fibers is below 700 ml, or preferably below 500 ml.

The alkali resistance of battery separators was further enhanced when employing lyocell fibers wherein the R10-value, the R18-value and the hemicellulose content of the lyocell fibers is as follows:
R10>89%
R18>97%
Hemicellulose content <2%.

Such lyocell fibers showed excellent alkali resistance, thus they were particularly suitable to make separators with extremely low Reduction by Weight in KOH. Nevertheless Lyocell fibers having extremely high R18- and R10-values and extremely low hemicellulose content are more difficult to beat. Thus, it is more difficult to obtain fine fibrils that are suitable for making separators with low shrinkage in KOH and suitable porosity.

The battery separator according to the present invention may comprise a mixture of lyocell fibers exhibiting the R10-values, R18-values and hemicellulose content as set out above.

In an especially preferred embodiment of the present invention, the lyocell fibers are mercerised.

Mercerising cellulosic fibers is well-known in the textile industry for modifying yarns and fabric properties and achieve special performances. In short, mercerising means the treatment of the fiber, yarn or fabric with an alkaline solution, especially NaOH-solution. The effects of mercerisation on the fiber structure of, inter alia, lyocell fibers have, inter alia, been discussed in Stana-Kleinschek et al., Correlation of regenerated cellulose fibers morphology and surface free energy components, Lenzinger Berichte 82 (2003), 83-95 and Colom, X., Carrillo, F., Crystallinity changes in lyocell and viscose-type fibers by caustic treatment, Europ. Polymer J. 38 (2002), 2225-2230. Mercerisation of fabrics containing lyocell fiber is disclosed in WO 95/024524 A1.

It has been found that mercerised pulp (which is a cellulosic fiber, but not a man-made cellulosic fiber that has been spun from a cellulose-containing solution, like lyocell fiber) exhibits high alkali resistance when used in a battery separator, but exhibits a poor fibrillation ability (cf. U.S. Pat. No. 7,781,104 B2). Apparently, the mercerisation treatment performed on the pulp negatively influences the fibrillation ability of the pulp.

In contrast therto, it has been found that mercerised lyocell fibers not only exhibit high alkali resistance when used in a battery separator, but also high fibrillation ability.

The R10-value and the R18-value of the mercerised lyocell fibers employed according to this preferred embodiment of the invention is preferably as follows:
R10>87%, preferably >93%
R18>95%, preferably >98%.

It has been found that in spite of these very high R10- and R18-values, the lyocell fibers not only exhibit excellent alkali resistance, but still show good fibrillation ability during the refining process.

The amount of the lyocell fibers fulfilling the above requirements in the separator may range from 1% to 100%, preferably 15% or more, 25% or more, 40% or more, or 50% or more.

The separator may comprise other constituents known to the skilled artisan, such as PVA fibers and PVA binders, pulp, viscose fibers or also lyocell fibers that do not fulfil the requirements regarding R10-value, R18-value and hemicellulose content.

The separator may be of any known design, such as a monolayer or multi-layer design.

In multi-layer structures at least one layer should be a nonwoven layer.

In such embodiments, there may be one or more additional layer(s) which can be selected from the group consisting of nonwovens or microporous layers (films), for example cellophane, PVA, polyamide, polyester or polyolefins.

In some embodiments the layers may be glued or thermally bonded together. Each layer may be coated with particles (like inorganic particles), may be grafted, treated with surfactants or corona treated. This kind of treatment may be symmetrical or asymmetrical, as described in US2012/028103A1.

Moreover the separator may include functional substances that have an “ions-trapping” function. They can selectively block molecules that reduce the battery performance (US2011/0117413A1).

It was found that battery separators comprising the lyocell fibers fulfilling the requirements according to the present invention exhibit advantageous properties, such as
A Reduction by Weight in KOH of <6.0%, preferably 5.5% or less, more preferably 5% or less, most preferably 4% or less
A Reduction by Area in KOH of <4.5%, preferably 3.5% or less, most preferably 2% or less and/or
A Frazier Air Permeability of <50 cm³/cm²/s, preferably 20 cm³/cm²/s, most preferred from 3.5 cm³/cm²/s to 15 cm³/cm²/s.

In the case of mercerised lyocell fibers, even more preferable properties in terms of Reduction by Weight in KOH and Reduction by Area in KOH can be obtained, such as
A Reduction by Weight in KOH of <3.5%, preferably 2.5% or less
A Reduction by Area in KOH of <3.0%, preferably 1.0% or less.

The lyocell fibers to be employed according to the present invention may exhibit a titer in the range of 0.2-10 dtex, preferably 0.2-2 dtex. The length of the fibers may be in the range of 1-20 mm, preferably 2-10 mm. The diameter of the fibrils after refining the fibers may be between 50 nm and 10.000 nm.

A lyocell fiber fulfilling the requirements according to the present invention and exhibiting a length of from 2 to 10 mm has not been proposed before.

Lyocell fibers fulfilling the requirements according to the present invention can be made from cellulosic starting materials, especially pulps or pulp mixtures, having corresponding properties in terms of R10-value, R18-value and hemicellulose content.

Thus, for making the lyocell fibers to be employed according to the present invention
All components of the cellulosic starting material should exhibit
R18>94%,
R10>85% and
Hemicellulose <3%
At least 50% in weight of the cellulosic starting material should exhibit
R18>96%,
R10>90% and
Hemicellulose <3%.

In order to produce lyocell fibers with a very high R10- and R18-value, at least 50% in weight of the cellulosic starting material should exhibit
R18>98%,
R10>97% and
Hemicellulose <1%

Pulps fulfilling the above requirements are commercially available and/or can be produced by the skilled artisan according to the respective needs of the production, see for example US 2009/0312536 A1 or WO 2005/118950.

The cellulosic starting material may also include cotton linters.

Alternatively, lyocell fibers exhibiting the R10-values, R18-values according to the present invention can also be obtained by mercerising lyocell fiber.

Typically, mercerisation is carried out with a NaOH-solution. The concentration of NaOH in the solution may preferably be from 5 wt. % to 20 wt. %. The duration of the treatment (residential time of the fibers in the treatment bath) may preferably be from 120 to 480 seconds.

Mercerisation may be carried out within the fiber production line just before the cutting step, where the fibers are still in the form of continuous filaments called “tow”. Alternatively, mercerisation may be carried out in the fiber production line after cutting, when the fibers are already in the form of “staple” or “short cut” fiber. Of course, mercerisation can also be carried out off-line.

The mercerisation can be applied to any type of lyocell fibers, independently from the pulp types or other conditions used for the production of the fibers. If as the starting material for mercerisation lyocell fibers are employed the R10- and R18-values of which are already high, notably where the R10- and R18-values already meet the requirements of the present invention (because they have been made from a pulp as specified above), excellent results can be obtained.

### Examples

### Test Methods

### Test Method for Determining Hemicellulose Content

Principle: Two step sulphuric acid hydrolysis followed by quantification of the obtained monosaccharides by anion exchange chromatography.

Procedure:

Hydrolysis:

About 50 mg of the sample is placed in a culture-C-tube (Wheaton) equipped with a small magnetic stirrer. Then 0.5 ml of 72.3% sulphuric acid is added under vigorous stirring and the reaction tube is closed. The mixture is kept at room temperature for 3 hours with frequent stirring to properly dissolve the sample.

For the second hydrolysis step 8.5 ml water is added and the reaction vessel is placed into a heating block and heated to 110° C. for 90 min.

The sample solution is cooled, filtered (0.45 μm), diluted 50-fold and neutralized with sodium hydroxide

Chromatography:

Column: Dionex CarboPac PA10 4*50+4*250 mm

Eluent A: MilliQ water

Eluent B: 0.35 M sodium hydroxide

Flow Rate: 1 ml/min

Temperature: ambient

Injection volume: 20 μl

Post column reagent: 0.35 M sodium hydroxide (0.8 ml/min)

Detection: pulsed amperometric detection (Dionex ED40)

Run time: 51 min

Gradient Program

| Time [min] | Eluent A [%] | Eluent B [%] | Comment |
|---|---|---|---|
| 0.0 | 100 | 0 | separation |
| 33.5 | 100 | 0 | |
| 34.0 | 0 | 100 | regeneration |
| 36.0 | 0 | 100 | |
| 36.5 | 100 | 0 | conditioning |
| 51 | 100 | 0 | end |

However, chromatography can also be carried out with other anion exchange columns with equivalent results.

The evaluation and quantification of the results of the chromatography is well-known to the skilled artisan.

### Tests on Paper:

### Basis Weight

Measured according to EDANA standard WSP130.1

### Thickness

Measured according to ASTM D1777

### Density Calculated:

Density (g/cm³)=(Basis Weight [g/m²]/10000)/(Thickness [μm]/10000)

### Alkali Proof (Area Shrinkage Rate in KOH)

Procedure:
cut a square sheet 120 mm×120 mm (A1). Cut carefully the specimen where the paper is uniform.
immerse it in 40% KOH solution at 70° C.
keep in the bath for 8 hours
measure the area of the wet sample (A2)

Area shrinkage rate (%)=(A1−A2)/A1×100

### Alkali Proof (Weight Reduction Rate in KOH)

Procedure:
cut one or more pieces of separator with a weight of approximately 5 g
dry the sample at 80° C. for 1 hour
weigh the dried sample (W1)
immerse it in 40% KOH solution at 70° C.
keep in the bath for 8 hours
wash the sample with water
dry the sample at 80° C. for 1 hour
weigh the dried sample (W2)

Weight reduction rate (%)=(W1−W2)/W1×100

### Frazier Air Permeability

Air permeability was measures according to JIS 1096-6,27.

The differential pressure of the air flow passing through the material was 0.5 inches of water.

### Porosity

It was calculated dividing the paper basis weight (g/m²) by the polymer density (g/cm³) and by the paper thickness (μm), multiplying by 100 and finally subtracting the result by 100.

Porosity (%)=100−(basis weight/[density×thickness]×100)

### Manufacture of Lyocell Fibers

Lyocell fibers were manufactured according to methods known as such to the skilled artisan from different pulps. The properties of the pulps employed, their respective amount in the fiber produced therefrom, and the properties of the resulting fibers are listed in the following table:

TABLE 1

| | | | Fiber Examples | | | | | | | |
|---|---|---|---|---|---|---|---|---|---|---|
| | | | (Percent of respective Pulp type in Fiber) | | | | | | | |
| | | ref. | A | G | H | B | F | C | D | Q |
| Pulp type | | | | | | | | | | |
| Pulp type | Xylan, % | 2.6 | | | | | | | | |
| 1 | Mannan, % | 0.7 | 100 | | | | | | | |
| | Tot. | 3.3 | | | | | | | | |
| | Hemicellulose,% | | | | | | | | | |
| | R10, % | 82.2 | | | | | | | | |
| | R18, % | 92.7 | | | | | | | | |
| Pulp type | Xylan, % | 7.3 | | 100 | 50 | 20 | | | | |
| 2 | Mannan, % | 5.3 | | | | | | | | |
| | Tot. | 12.6 | | | | | | | | |
| | Hemicellulose,% | | | | | | | | | |
| | R10, % | 83.3 | | | | | | | | |
| | R18, % | 89.4 | | | | | | | | |
| Pulp type | Xylan, % | 2.5 | | | 50 | 80 | 100 | 50 | | |
| 3 | Mannan, % | 0.4 | | | | | | | | |
| | Tot. | 2.9 | | | | | | | | |
| | Hemicellulose,% | | | | | | | | | |
| | R10, % | 85.9 | | | | | | | | |
| | R18, % | 94.9 | | | | | | | | |
| Pulp type | Xylan, % | 2.4 | | | | | | 50 | 100 | |
| 4 | Mannan, % | 0 | | | | | | | | |
| | Tot. | 2.4 | | | | | | | | |
| | Hemicellulose,% | | | | | | | | | |
| | R10, % | 92.6 | | | | | | | | |
| | R18, % | 97.2 | | | | | | | | |
| Pulp type | Xylan, % | 1.6 | | | | | | | | 50 |
| 5 | Mannan, % | 0.2 | | | | | | | | |
| | Tot. | 1.8 | | | | | | | | |
| | Hemicellulose,% | | | | | | | | | |
| | R10, % | 93.6 | | | | | | | | |
| | R18, % | 97.4 | | | | | | | | |
| Pulp type | Xylan, % | 0.5 | | | | | | | | 50 |
| 6 | Mannan, % | 0 | | | | | | | | |
| | Tot. | 0.5 | | | | | | | | |
| | Hemicellulose,% | | | | | | | | | |
| | R10, % | 98.6 | | | | | | | | |
| | R18, % | 99.5 | | | | | | | | |

| | | | | | | | | |
|---|---|---|---|---|---|---|---|---|
| Fiber properties: | | | | | | | | |
| dtex | 1.7 | 1.7 | 1.3 | 1.7 | 1.3 | 1.7 | 1.7 | 1.3 |
| length, mm | 4 | 5 | 5 | 4 | 5 | 4 | 5 | 5 |
| Xylan, % | 2 | 7.3 | 4.3 | 3 | 1.6 | 2.1 | 2.6 | 1.1 |
| Mannan, % | 0.2 | 4.9 | 2.3 | 1.6 | 0.2 | 0.2 | 0.1 | 0.1 |
| Tot. Hemicellulose, % | 2.2 | 12.2 | 6.6 | 4.6 | 1.8 | 2.3 | 2.7 | 1.2 |
| R10, % | 80.1 | 75.2 | 78 | 82.4 | 79.9 | 85.7 | 88.1 | 89.7 |
| R18, % | 93.3 | 83.4 | 88.8 | 92.3 | 93.8 | 95.2 | 96.4 | 97.5 |

Accordingly, fiber examples C, D and Q fulfil the requirements according to the present invention. Fibers A, G, H, B and F constitute comparative examples.

Refining

Lyocell fibers were refined with a Valley Beater according to ISO 5264-1.

Pulp fibers were refined with a PFI U3000 mill according to ISO 5264-2.

Paper Samples

Paper samples were prepared with a RAPID-KÖTHEN sheet former, according to EN ISO 5269/2.

Various papers were manufactured from the fibers as summarized above, optionally in a mixture with other constituents.

The composition of the paper samples as well as the properties determined therein are summarized in the following tables:

TABLE 2
Examples according to the invention:

| | | Ex. | Ex. | Ex. | Ex. | Ex. | Ex. | Ex. | Ex. |
|---|---|---|---|---|---|---|---|---|---|
| | | 1 | 2 | 3 | 4 | 5 | 6 | 7 | 8 |
| Paper | PVA binder, 1.1 | | | | 15 | 15 | 15 | 15 | 15 |
| Compo- | dtex, 3 mm | | | | | | | | |
| sition, % | PVA fibers, 1.1 | | | | 35 | 35 | 35 | 35 | 35 |
| | dtex, 2 mm | | | | | | | | |
| | Eucalyptus pulp | | | | | | | | |
| | (CSF = 460 ml) | | | | | | | | |
| | Mercerized wood | | | | | | | | |
| | pulp | | | | | | | | |
| | (CSF > 700 ml) | | | | | | | | |
| | Cotton Linters | | | | | | | | |
| | pulp | | | | | | | | |
| | (CSF > 700 ml) | | | | | | | | |
| | Viscose fibers, | | | | | | | | |
| | 0.9 dtex, 3 mm | | | | | | | | |
| | Lyocell Ex. | 100 | | | 50 | | | 25 | 15 |
| | C, 150 ml CSF | | | | | | | | |
| | Lyocell Ex. | | 100 | | | 50 | | | |
| | D, 150 ml CSF | | | | | | | | |
| | Lyocell Ex. | | | 100 | | | 50 | | |
| | Q, >700 ml CSF | | | | | | | | |
| | Lyocell Ex. | | | | | | | 25 | 35 |
| | A, 150 ml CSF | | | | | | | | |
| Paper | Basis weight , | 48 | 46 | 47 | 46 | 46 | 46 | 45 | 45 |
| properti | g/m² | | | | | | | | |
| | Thickness, μm | 107 | 101 | 117 | 123 | 126 | 126 | 119 | 120 |
| | Density, g/cm³ | 0.45 | 0.46 | 0.40 | 0.37 | 0.37 | 0.37 | 0.38 | 0.38 |
| | Porosity, % | 70 | 70 | 73 | 72 | 73 | 73 | 71 | 72 |
| | Weight | 5.7 | 5.6 | 2.6 | 3.3 | 3.7 | 2.0 | 4.6 | 5.2 |
| | Reduction rate in | | | | | | | | |
| | KOH, % | | | | | | | | |
| | Area Shrinkage | 3.1 | 2.9 | 4.2 | 1.9 | 1.5 | 2.4 | 1.8 | 1.7 |
| | rate in KOH, % | | | | | | | | |
| | Frazier Air | 1.8 | 1.2 | 66.0 | 7.2 | 4.4 | 73.0 | 6.3 | 5.0 |
| | Permeability, | | | | | | | | |
| | cm³/cm²/sec | | | | | | | | |

TABLE 3
Comparative Examples

| | | Ex. | Ex. | Ex. | Ex. | Ex. | Ex. |
|---|---|---|---|---|---|---|---|
| | | 9 | 10 | 11 | 12 | 13 | 14 |
| Paper | PVA binder, 1.1 dtex, | | | 15 | 15 | 15 | 15 |
| Compo- | 3 mm | | | | | | |
| sition, % | PVA fibers, 1.1 dtex, | | | 35 | 35 | 35 | 35 |
| | 2 mm | | | | | | |
| | Eucalyptus pulp | | | | 25 | | |
| | (CSF = 460 ml) | | | | | | |
| | Mercerized wood | | | | | | 50 |
| | pulp (CSF > 700 ml) | | | | | | |
| | Cotton Linters pulp | | | | | 50 | |
| | (CSF > 700 ml) | | | | | | |
| | Viscose fibers, | | | | 25 | | |
| | 0.9 dtex, 3 mm | | | | | | |
| | Lyocell Ex. B, | 100 | | | | | |
| | 150 ml CSF | | | | | | |
| | Lyocell Ex. A, | | 100 | 50 | | | |
| | 150 ml CSF | | | | | | |
| Paper | Basis weight , g/m² | 48 | 48 | 46 | 45 | 46 | 47 |
| prop- | Thickness, μm | 108 | 110 | 121 | 111 | 121 | 120 |
| erties | Density, g/cm³ | 0.44 | 0.44 | 0.38 | 0.41 | 0.38 | 0.39 |
| | Porosity, % | 70 | 71 | 72 | 70 | 72 | 71 |
| | Weight Reduction | 7.1 | 10.0 | 5.9 | 6.9 | 1.2 | 3.6 |
| | rate in KOH, % | | | | | | |
| | Area Shrinkage rate | 2.8 | 3.3 | 1.7 | 9.0 | 8.6 | 3.1 |
| | in KOH, % | | | | | | |
| | Frazier Air | 0.7 | 2.1 | 6.8 | 28.0 | 60.0 | 71.0 |
| | Permeability, | | | | | | |
| | cm³/cm²/sec | | | | | | |

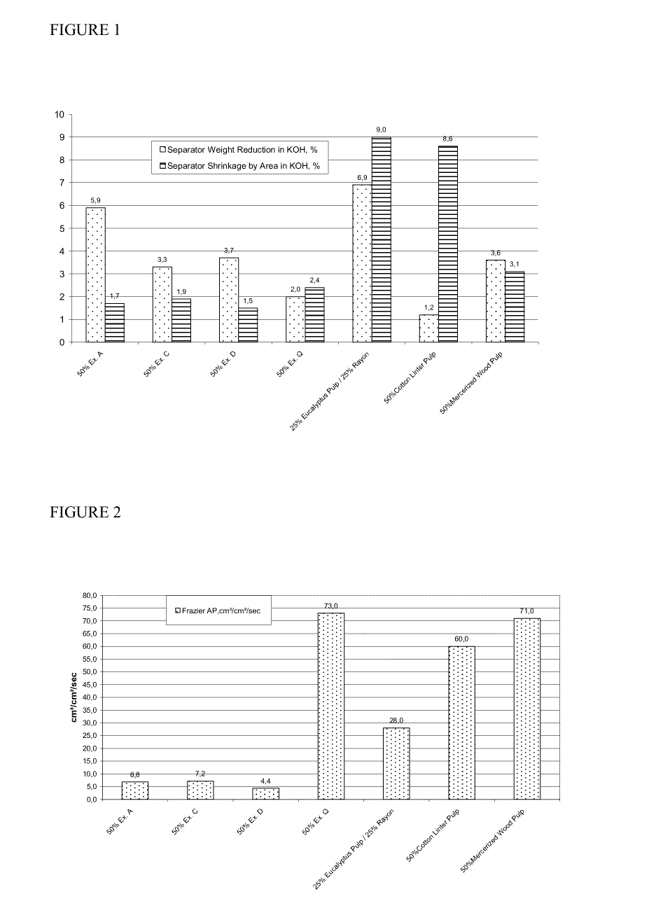

FIGS. 1 and 2 demonstrate the Alkali Resistance (FIG. 1) and Air Permeability (FIG. 2) properties of some of the above examples plus some additional comparative examples containing no lyocell fiber.

In each case, the battery separator contained 50% cellulosic component (lyocell fibers according to the present invention, lyocell fibers not according to the present invention or other cellulosic materials such as eucalyptus pulp, rayon, cotton linter pulp and mercerized wood pulp) and 35% PVA fibers as well as 15% PVA binder.

Use of Mercerised Lyocell Fiber

Lyocell fibers produced from the same starting materials and spun under the same conditions as for examples B and C above were mercerised in aqueous NaOH-solutions in the tow form. The fibers were then cut to a length of 3 mm. The mercerisation process employed the following parameters:
Concentration of NaOH (%): 5-10-15-20
Residential time (s): 120-240-480
Bath temperature (° C.): 25

The alkali resistances of the mercerised fibers in terms of R10-value and R18-value were determined.

The respective test regimes and results in terms of R10-value and R18-value are summarized in the following table:

TABLE 4
Test Regimes for mercerisation and results

| | | Mercerisation conditions | | | | |
|---|---|---|---|---|---|---|
| | | NaOH | | Bath | | |
| | | concen- | Resi- | Temper- | Alkali | |
| | Starting | tration | dential | ature, | Resistance | |
| example | fibers | (%) | time (s) | ° C. | R10% | R18% |
| C-1-0 | Example C | 0 | 0 | 25 | 85.7 | 95.2 |
| C-1-1 | Example C | 5 | 120 | 25 | 87.0 | 97.0 |
| C-1-2 | Example C | 10 | 120 | 25 | 91.3 | 98.4 |
| C-1-3 | Example C | 15 | 120 | 25 | 94.5 | 98.9 |
| C-1-4 | Example C | 20 | 120 | 25 | 94.5 | 98.7 |
| C-2-4 | Example C | 5 | 240 | 25 | 87.0 | 96.9 |
| C-3-1 | Example C | 10 | 240 | 25 | 93.5 | 98.6 |
| C-2-6 | Example C | 15 | 240 | 25 | 96.5 | 99.3 |
| C-3-2 | Example C | 20 | 240 | 25 | 96.8 | 98.5 |
| C-3-3 | Example C | 5 | 480 | 25 | 87.0 | 96.9 |
| C-3-4 | Example C | 10 | 480 | 25 | 95.3 | 98.6 |
| C-3-5 | Example C | 15 | 480 | 25 | 96.7 | 98.7 |
| C-3-6 | Example C | 20 | 480 | 25 | 96.9 | 98.6 |
| B-4-0 | Example B | 0 | 0 | 25 | 82.4 | 92.3 |
| B-4-1 | Example B | 5 | 240 | 25 | 83.3 | 95.0 |
| B-4-2 | Example B | 10 | 240 | 25 | 93.4 | 97.2 |
| B-4-3 | Example B | 15 | 240 | 25 | 95.4 | 97.7 |
| B-4-4 | Example B | 20 | 240 | 25 | 94.8 | 97.9 |

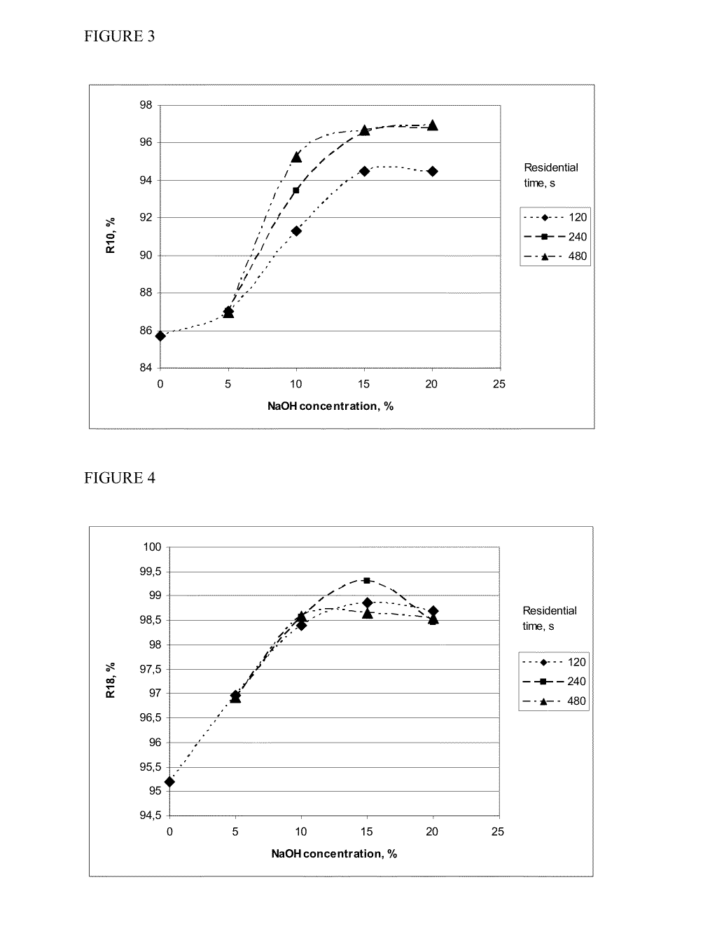

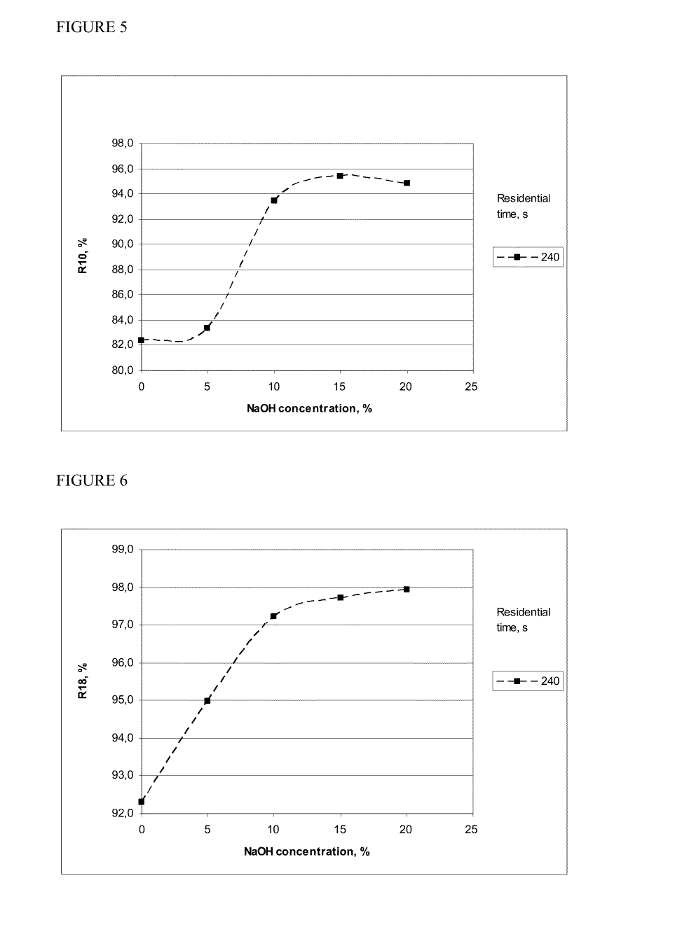

The results are shown graphically in FIG. 3 (R10-value) and FIG. 4 (R18-value) concerning the fiber of Example C, and FIG. 5 (R10-value) and FIG. 6 (R18-value concerning the fiber of Example B.

One can see that the R10-values and R18-values of lyocell fibers that already fulfil the requirements of the present invention (Example C) are further enhanced by a mercerisation treatment, and those of lyocell fibers that do not fulfil the requirements of the present invention (Example B) can be increased such as to fulfil the requirements by a mercerisation treatment.

A Schopper-Riegler-test was performed on the unmercerised fiber of Example B and the mercerised fiber according to Example B-4-3 above in a Valley Beater.

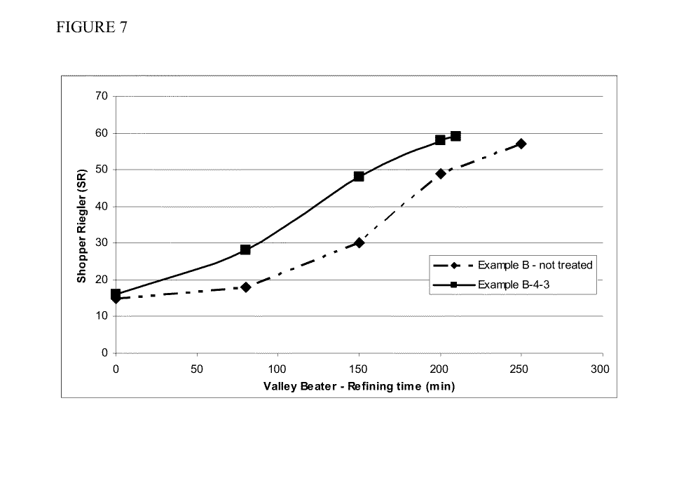

The results of the tests are shown in FIG. 7. One can clearly see that the mercerised fiber develops higher Schopper-Riegler-values within a shorter refining time. This means that the mercerised lyocell fiber has a high degree of fibrillation.

Papers were manufactured, as described above, from the mercerised fibers described above, optionally in a mixture with other constituents.

The composition of the paper samples as well as the properties determined therein are summarized in the following tables:

TABLE 5
Paper samples

| | | Ex. | Ex. | Ex. | Ex. | Ex. | Ex. | Ex. | Ex. |
|---|---|---|---|---|---|---|---|---|---|
| | | 15 | 16 | 17 | 18 | 19 | 20 | 21 | 22 |
| Paper | PVA binder, 1.1 dtex, 3 mm | | | | | | | | 15 |
| Compo- | PVA fibers, 1.1 dtex, 2 mm | | | | | | | | 35 |
| sition, % | Eucalyptus pulp (CSF = 460 ml) | | | | | | | | |
| | Mercerized wood pulp (CSF > 700 ml) | | | | | | | | |
| | Cotton Linters pulp (CSF > 700 ml) | | | | | | | | |
| | Viscose fibers, 0.9 dtex, 3 mm | | | | | | | | |
| | Lyocell example C-1-1, 150 ml CSF | 100 | | | | | | | 50 |
| | Lyocell exampleC-1-3, 150 ml CSF | | 100 | | | | | | |
| | Lyocell example C-2-6, 150 ml CSF | | | 100 | | | | | |
| | Lyocell example C-3-2, 150 ml CSF | | | | 100 | | | | |
| | Lyocell example C-3-4, 150 ml CSF | | | | | 100 | | | |
| | Lyocell example B-4-3, 150 ml CSF | | | | | | 100 | | |
| | Lyocell example B-4-4, 150 ml CSF | | | | | | | 100 | |
| Paper | Basis weight, g/m² | 45 | 44 | 46 | 45 | 45 | 43 | 43 | 44 |
| Prop- | Thickness, μm | 101 | 99 | 102 | 101 | 108 | 105 | 105 | 124 |
| erties | Density, g/cm³ | 0.45 | 0.44 | 0.45 | 0.45 | 0.42 | 0.42 | 0.41 | 0.35 |
| | Porosity, % | 67 | 67 | 67 | 67 | 69 | 70 | 70 | 74 |
| | Weight Reduction rate in KOH, % | 5.2 | 5.0 | 3.9 | 2.8 | 3.5 | 5.0 | 3.5 | 2.8 |
| | Area Shrinkage rate in KOH, % | 4 | 2 | 1.4 | 1.7 | 2.4 | 2.7 | 1.2 | 1.9 |
| | Frazier Air Permeability, cm³/cm²/sec | 2.2 | 1.8 | 3.9 | 1.9 | 4.2 | 3.2 | 1.6 | 5.6 |

| | | Ex. | Ex. | Ex. | Ex. | Ex. | Ex. |
|---|---|---|---|---|---|---|---|
| | | 23 | 24 | 25 | 26 | 27 | 28 |
| Paper | PVA binder, 1.1 dtex, 3 mm | 15 | 15 | 15 | 15 | 15 | 15 |
| Compo- | PVA fibers, 1.1 dtex, 2 mm | 35 | 35 | 35 | 35 | 35 | 35 |
| sition, % | Eucalyptus pulp (CSF = 460 ml) | | | | | | |
| | Mercerized wood pulp (CSF > 700 ml) | | | | | | |
| | Cotton Linters pulp (CSF > 700 ml) | | | | | | |
| | Viscose fibers, 0.9 dtex, 3 mm | | | | | | |
| | Lyocell example C-1-1, 150 ml CSF | | | | | | |
| | Lyocell exampleC-1-3, 150 ml CSF | 50 | | | | | |
| | Lyocell example C-2-6, 150 ml CSF | | 50 | | | | |
| | Lyocell example C-3-2, 150 ml CSF | | | 50 | | | |
| | Lyocell example C-3-4, 150 ml CSF | | | | 50 | | |
| | Lyocell example B-4-3, 150 ml CSF | | | | | 50 | |
| | Lyocell example B-4-4, 150 ml CSF | | | | | | 50 |
| Paper | Basis weight, g/m² | 45 | 44 | 44 | 42 | 43 | 44 |
| Prop- | Thickness, μm | 123 | 128 | 123 | 124 | 105 | 123 |
| erties | Density, g/cm³ | 0.37 | 0.34 | 0.36 | 0.34 | 0.41 | 0.36 |
| | Porosity, % | 73 | 75 | 74 | 75 | 70 | 74 |
| | Weight Reduction rate in KOH, % | 3.0 | 2.3 | 1.6 | 2.1 | 2.9 | 1.7 |
| | Area Shrinkage rate in KOH, % | 0.9 | 0.6 | 1.1 | 0.9 | 1 | 0.8 |
| | Frazier Air Permeability, cm³/cm²/sec | 6.1 | 9.2 | 12.3 | 14.3 | 25.2 | 13.6 |

TABLE 6
Comparison Examples

| | | Ex. | Ex. | Ex. | Ex. | Ex. |
|---|---|---|---|---|---|---|
| | | 29 | 30 | 31 | 32 | 33 |
| Paper | PVA binder, 1.1 dtex, 3 mm | 15 | 15 | 15 | 15 | 15 |
| Compo- | PVA fibers, 1.1 dtex, 2 mm | 35 | 35 | 35 | 35 | 35 |
| sition, % | Eucalyptus pulp (CSF = 460 ml) | | | 25 | | |
| | Mercerized wood pulp (CSF > 700 ml) | | | | | 50 |
| | Cotton Linters pulp (CSF > 700 ml) | | | | 50 | |
| | Viscose fibers, 0.9 dtex, 3 mm | | | 25 | | |
| | Lyocell Example B - Not | 50 | | | | |
| | Mercerised, 150 CSF | | | | | |
| | Lyocell Example C - Not | | 50 | | | |
| | Mercerised, 150 CSF | | | | | |
| Paper | Basis weight, g/m² | 46 | 45 | 45 | 46 | 47 |
| prop- | Thickness, μm | 118 | 117 | 111 | 121 | 120 |
| erties | Density, g/cm³ | 0.38 | 0.4 | 0.41 | 0.38 | 0.39 |
| | Porosity, % | 70 | 72 | 70 | 72 | 71 |
| | Weight Reduction rate in KOH, % | 5.1 | 3.5 | 6.9 | 1.2 | 3.6 |
| | Area Shrinkage rate in KOH, % | 1.9 | 1.8 | 9 | 8.6 | 3.1 |
| | Frazier Air Permeability, | 7.2 | 8.7 | 28 | 60 | 71 |
| | cm³/cm²/sec | | | | | |

Comparing Comparison Example 29 with Inventive Examples 27 and 28 and Comparison Example 30 with Inventive Examples 22 to 26, respectively, there is a (further) remarkable reduction in the Weight Reduction rate in KOH obtained by employing mercerised lyocell fiber instead of non-mercerised lyocell fiber.

1. A battery separator, comprising cellulosic fibers of the lyocell genus, wherein the R10-value, the R18-value and the hemicellulose content of the lyocell fibers is as follows:
R10>83%,
R18>93%, and
Hemicellulose content <3%.

2. The battery separator according to claim 1, wherein the R10-value, the R18-value and the hemicellulose content of the lyocell fibers is as follows:
R10>89%,
R18>97%, and
Hemicellulose content <2%.

3. The battery separator according to claim 1, wherein the separator comprises a mixture of lyocell fibers exhibiting the R10-values, R18-values and hemicellulose content as defined.

4. The battery separator according to claim 1, wherein the lyocell fibers are mercerized.

5. The battery separator according to claim 4, wherein the R10-value and the R18-value of the mercerized lyocell fibers is as follows:
R10>87%, and
R18>95%.

6. The battery separator according to claim 1, wherein the amount of said lyocell fibers in the separator is from 1% to 100%.

7. The battery separator according to claim 1, wherein the separator exhibits a Reduction by Weight in KOH of <6.0%.

8. The battery separator according to claim 7, wherein the separator exhibits a Reduction by Area in KOH of <4.5%.

9. The battery separator according to claim 1, wherein the separator exhibits a Frazier Air Permeability of <50 cm³/cm²/s.

10. A method of using a cellulosic fiber of the lyocell genus comprising including the fiber in a battery separator, said fiber exhibiting
a value for R10>83%,
a value for R18>93%, and
a hemicellulose content <3%.

11. The method according to claim 10, wherein the lyocell fiber is mercerized.

12. A cellulosic fiber of the lyocell genus, said fiber exhibiting
a value for R10>83%,
a value for R18>93%,
a hemicellulose content <3%, and
a length of from 2 to 10 mm.

13. The cellulosic fiber according to claim 12, wherein the lyocell fiber is mercerized.

14. A battery comprising the battery separator according to claim 1.

15. The battery separator according to claim 1, wherein the R10-value is >84%.

16. The battery separator according to claim 1, wherein the R18-value is >94%.

15. The battery separator according to claim 5, wherein the R10-value is >93%.

16. The battery separator according to claim 5, wherein the R18-value is >98%.

17. Battery separator according to claim 6, wherein the amount of said lyocell fibers in the separator is from 15% to 100%.

18. Battery separator according to claim 17, wherein the amount of said lyocell fibers in the separator is from 25% to 100%.

19. Battery separator according to claim 18, wherein the amount of said lyocell fibers in the separator is from 40% to 100%.

20. Battery separator according to claim 19, wherein the amount of said lyocell fibers in the separator is from 50% to 100%.

21. The battery separator according to claim 7, wherein the separator exhibits a Reduction by Weight in KOH of <5.5%.

22. The battery separator according to claim 21, wherein the separator exhibits a Reduction by Weight in KOH of <5%.

23. The battery separator according to claim 8, wherein the separator exhibits a Reduction by Weight in KOH of <4%.

24. The battery separator according to claim 23, wherein the separator exhibits a Reduction by Weight in KOH of <3.5%.

25. The battery separator according to claim 24, wherein the separator exhibits a Reduction by Weight in KOH of <2%.

26. The battery separator according claim 9, wherein the separator exhibits a Frazier Air Permeability of <20 cm³/cm²/s.

27. The battery separator according claim 26, wherein the separator exhibits a Frazier Air Permeability from 3.5 cm³/cm²/s to 15 cm³/cm²/s.

28. The method of claim 10, wherein the fiber exhibits a value for R10>84%.

29. The method of claim 10, wherein the fiber exhibits a value for R18>94%.

30. The cellulosic fiber of claim 12, wherein the fiber exhibits a value for R10>84%.

31. The cellulosic fiber of claim 12, wherein the fiber exhibits a value for R18>94%.

32. The battery according to claim 14, wherein the battery is an alkaline battery.
